(19) United States
(12) Patent Application Publication
(10) Pub. No.: US 2026/0160328 A1
(43) Pub. Date: Jun. 11, 2026

(54) PLANETARY CARRIER, PLANETARY GEAR SET, AND WIND TURBINE

(71) Applicants: ZF FRIEDRICHSHAFEN AG, Friedrichshafen (DE); ZF Wind Power Antwerpen N.V., Lommel (BE)

(72) Inventors: Wim SMET, Temse (BE); Arno KLEIN-HITPASS, Aachen (DE)

(21) Appl. No.: 19/403,048

(22) Filed: Nov. 27, 2025

(30) Foreign Application Priority Data
Dec. 6, 2024 (DE) 10 2024 211 666.1

(51) Int. Cl. F16H 57/08

(52) U.S. Cl. CPC F16H 57/082

(57) ABSTRACT

A planetary carrier for a planetary gear set includes with a first wall element, a second wall element, and a planetary bolt. The planetary bolt rotatably supports a planetary gear. The first wall element and the second wall element are fastened to each other with at least one clamping device. The planetary bolt is clamped between the first wall element and the second wall element by the clamping device.

### CROSS REFERENCE TO RELATED APPLICATIONS

This application claims benefit to German Patent Application No. DE 10 2024 211 666.1, filed on December 6, 2024, which is hereby incorporated by reference herein.

### FIELD

The present disclosure relates to a planetary carrier. In addition, the disclosure relates to a planetary gear set and a wind turbine.

### BACKGROUND

Planetary carriers usually form one of the rotating elements in a planetary gear set of a gearbox. Several planetary gears are thereby rotatably mounted on the planetary carrier, which mesh with a sun gear and a ring gear, for example. The torque transmitted there can lead to high loads on the planetary carrier, which it must be able to withstand without excessive deformation. Excessive deformation can, for example, lead to a deviation in tooth engagement, which results in increased wear. At the same time, however, a planetary carrier should also be lightweight, easy to assemble, and inexpensive to manufacture.

### SUMMARY

In an embodiment, the present disclosure provides a planetary carrier for a planetary gear set includes with a first wall element, a second wall element, and a planetary bolt. The planetary bolt rotatably supports a planetary gear. The first wall element and the second wall element are fastened to each other with at least one clamping device. The planetary bolt is clamped between the first wall element and the second wall element by the clamping device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will

become apparent by reading the following detailed description with reference to the attached drawings, which illustrate the following:

FIG. 1 illustrates in a schematic perspective view, an example of a planetary carrier with two wall elements that are formed together in one piece, according to one or more embodiments of the present disclosure;

FIG. 2 illustrates in a schematic perspective view, a section of a first embodiment of a planetary carrier with two separate wall elements in an exploded view, according to one or more embodiments of the present disclosure;

FIG. 3 illustrates the planetary carrier according to FIG. 2 in a schematic perspective view, according to one or more embodiments of the present disclosure;

FIG. 4 illustrates a second embodiment of the planetary carrier in a schematic perspective view, according to one or more embodiments of the present disclosure;

FIG. 5 illustrates in a schematic sectional view, a first variant of a fastening of the planetary bolt to the two separate wall elements of the planetary carrier, according to one or more embodiments of the present disclosure;

FIG. 6 illustrates in a schematic sectional view, a second variant of the fastening of the planetary bolt to the two separate wall elements of the planetary carrier, according to one or more embodiments of the present disclosure;

FIG. 7 illustrates in a schematic sectional view, a third variant of the fastening of the planetary bolt to the two separate wall elements of the planetary carrier, according to one or more embodiments of the present disclosure;

FIG. 8 schematically illustrates in a sectional view, a first variant of an oil guide for lubricating a bearing of a planetary gear on the planetary bolt, according to one or more embodiments of the present disclosure;

FIG. 9 schematically illustrates in a sectional view, a second variant of the oil guide for lubricating the bearing of the planetary gear on the planetary bolt, according to one or more embodiments of the present disclosure;

FIG. 10 schematically illustrates in a sectional view, a third variant of the fastening of the planetary bolt to the two separate wall elements of the planetary carrier, according to one or more embodiments of the present disclosure;

FIG. 11 illustrates in a schematic cross-sectional view, a fourth variant of the fastening of the planetary bolt to the two separate wall elements of the planetary carrier, according to one or more embodiments of the present disclosure;

FIG. 12 illustrates in a schematic sectional view, a first variant of an arrangement of clamping elements of a clamping device, by means of which the two separate wall elements of the planetary carrier are fastened to each other, according to one or more embodiments of the present disclosure;

FIG. 13 illustrates in a schematic sectional view, a second variant of the arrangement of clamping elements of the clamping device, by means of which the two separate wall elements of the planetary carrier are fastened to each other, according to one or more embodiments of the present disclosure;

FIG. 14 illustrates in a schematic cross-sectional view, a third variant of the arrangement of clamping elements of the clamping device, by means of which the two separate wall elements of the planetary carrier are fastened to each other, according to one or more embodiments of the present disclosure;

FIG. 15 illustrates in a schematic cross-sectional view, a fourth variant of the arrangement of clamping elements of the clamping device, by means of which the two separate wall elements of the planetary carrier are fastened to each other, according to one or more embodiments of the present disclosure;

FIG. 16 illustrates in a schematic cross-sectional view, a fifth variant of the arrangement of clamping elements of the clamping device, by means of which the two separate wall elements of the planetary carrier are fastened to each other, according to one or more embodiments of the present disclosure;

FIG. 17 illustrates in a schematic cross-sectional view, a sixth variant of the arrangement of clamping elements of the clamping device, by means of which the two separate wall elements of the planetary carrier are fastened to each other, according to one or more embodiments of the present disclosure;

FIG. 18 illustrates in a schematic cross-sectional view, a seventh variant of the arrangement of clamping elements of the clamping device, by means of which the two separate wall elements of the planetary carrier are fastened to each other, according to one or more embodiments of the present disclosure;

FIG. 19 schematically illustrates in an unrolled view of the planetary carrier, a first variant of the fastening of the two separate wall elements to each other by means of the clamping device, according to one or more embodiments of the present disclosure;

FIG. 20 schematically illustrates in an unrolled view of the planetary carrier, a second variant of the fastening of the two separate wall elements to each other by means of the clamping device, according to one or more embodiments of the present disclosure;

FIG. 21 schematically illustrates in an unrolled representation of the planetary carrier, a third variant of the fastening of the two separate wall elements to each other by means of the clamping device, according to one or more embodiments of the present disclosure;

FIG. 22 schematically illustrates in an unrolled view of the planetary carrier, a fourth variant of the fastening of the two separate wall elements to each other by means of the clamping device, according to one or more embodiments of the present disclosure; and

FIG. 23 schematically illustrates a wind turbine, according to one or more embodiments of the present disclosure.

### DETAILED DESCRIPTION

A first aspect concerns a planetary carrier for a planetary gear set. The planetary gear set can, for example, form part of a gearbox. The gearbox can, for example, be configured as a vehicle gearbox or a gearbox for a power generation plant, such as a wind turbine.

The planetary carrier has a first wall element, a second wall element, and a planetary bolt. The planetary bolt can be held on the two wall elements. The two wall elements can be arranged axially next to each other. The axial direction, a radial direction, and a circumferential direction can be defined by an axis of rotation of the planetary carrier or also of the entire planetary gear set.

The two wall elements can, for example, extend essentially radially. The first wall element can, for example, form a connection area for an input shaft, a rotor of a wind turbine or also of a further planetary gear set. The second wall element can, for example, form a connection area for an output shaft, a generator of a wind turbine or also of a further planetary gear set. The two wall elements can, for example, be configured as castings or forgings. The two wall elements can also be configured as metal plates which have been manufactured, for example, in a punching process and, alternatively or additionally, in a deep-drawing process. Due to the configuration described here, the two wall elements can nevertheless withstand sufficiently high loads without impermissibly high deformation at low weight. In addition, production can thus be cost-effective. The two wall elements can be reworked using a machining process. The two wall elements can be spaced apart from each other and, alternatively or additionally, aligned essentially parallel to each other, for example, at least their respective sides facing each other. The two wall elements do not touch each other, for example. The first wall element and the second wall element can each be formed in one piece. The two wall elements can be two separate components. The wall elements can also be formed in several parts, for example, to provide stiffening at connection areas and, alternatively or additionally, to be able to use adapters for different gearboxes.

The planetary bolt is configured to rotatably support a planetary gear. For example, the planetary gear can be supported on the planetary bolt by a friction bearing or roller bearing. The planetary bolt can be a component separate from the two wall elements. The multi-part configuration makes it easy to assemble the planetary bolt and, overall, the planetary carrier and the planetary gear set. The planetary bolt can extend axially in its main direction of extension, for example, radially spaced from the axis of rotation of the planetary carrier. The planetary bolt can be a metallic component. The planetary carrier can have two, three, four, or more planetary bolts. The planetary bolts can be spaced apart from each other. The planetary bolts can be configured and assembled in the same way. Respective explanations below apply equally to multiple planetary bolts, where applicable. For example, at least one or exactly one associated planetary gear can be rotatably mounted on each planetary bolt.

Each planetary gear may have one or more toothed areas on its outer circumference. The planetary gear set may, for example, be configured as a minus planetary gear set or a plus planetary gear set. The planetary gears can, for example, mesh with a sun gear and a ring gear of the planetary gear set. The planetary gear set can, for example, have three rotating elements. Sun gears, ring gears, and planetary carriers can, for example, form rotating elements of a planetary gear set.

The wall elements are fastened to each other with a clamping device, whereby the planetary bolt is clamped between the two wall elements that are fastened to each other. The planetary bolt extends, for example, axially between the two wall elements. The planetary carrier can be configured such that the planetary bolt absorbs parts of the forces acting on the planetary carrier. The clamping allows, for example, tangentially acting forces that twist the planetary carrier to be transmitted between the two wall elements. The planetary bolts can additionally stiffen the planetary carrier, for example due to their clamping. In contrast, in planetary carriers with a one-piece wall that forms a cage for the respective planetary gears, forces are transmitted exclusively or at least to a greater extent via the walls. The planetary bolts therefore contribute nothing or very little to a stiffness of such a planetary carrier, which is why the wall or the cage may then be configured to be more robust. The at least two-part configuration of the wall of the planetary carrier with the two wall elements also results in other assembly options, such as stacking, which can make assembly easier.

The clamping device may, for example, comprise a clamping element such as a bolt or a screw. In addition, the clamping device may comprise a counter element such as a nut or a threaded plate. The clamping element may, for example, extend through both or only one of the two wall elements. For example, a screw may be arranged in a through-opening of the first wall element and screwed into a threaded hole of the second wall element. For example, a clamping element may extend through the first wall element and may be screwed into a threaded hole of the planetary bolt. Another clamping element may extend through the second wall element and may be screwed into another threaded hole in the planetary bolt. The clamping device may have a clamping lever for each clamping element. In this case, the planetary bolt can be clamped by flipping the lever instead of screwing it tight. For example, a screw may be arranged in a through-opening of the first wall element and the second wall element and screwed into a threaded hole in the counter element. The clamping device may also have several clamping elements spaced apart from one another. The clamping elements may, for example, be arranged corresponding to respective planetary bolts and alternatively or additionally to bridge elements described below.

In one embodiment, the planetary bolt is configured as a hollow shaft. For example, the planetary bolt may be configured in a tubular shape. The planetary bolt may have a thin circumferential wall. The planetary bolt may have an axially extending through-opening. The through-opening may be centrally located. The planetary bolt may also have several axially extending through-openings. The planetary bolt may thus be very light. Nevertheless, the planetary bolt may have a high moment of inertia and thus absorb high forces in the circumferential direction and transmit them between the two wall elements. The planetary bolt may have through-openings for the clamping elements and additionally one or more through-openings in which no clamping elements are arranged. Alternatively, instead of being configured as a hollow shaft, the planetary bolt may also be configured, for example, as a solid pin without a through-opening.

In one embodiment, it is provided that a clamping element of the clamping device is arranged inside the planetary bolt. For example, the clamping element extends axially through the planetary bolt. The wall of the planetary bolt then surrounds the clamping element radially. For example, the clamping element is arranged in the through-opening of the hollow shaft or in a further dedicated through-opening in the wall of the planetary bolt. This arrangement allows the planetary carrier to be particularly compact. In addition, the planetary bolt can be clamped particularly evenly in this way. Furthermore, the clamping elements can prevent the planetary bolt from falling out before it is clamped in the assembly position. The wall of the planetary bolt can radially enclose the clamping element. For example, several clamping elements can also be arranged within the planetary bolt. The clamping elements can be spaced apart from each other. Some clamping elements can also be arranged inside and some clamping elements outside the respective planetary bolts.

In one embodiment, it is provided that the planetary carrier exhibits a sleeve which is arranged inside the planetary bolt. The sleeve can be configured as a hollow shaft which has a smaller diameter than the planetary bolt. However, the sleeve can also be configured in a solid manner, for example in the form of a pin. For example, no planetary gear is mounted on the sleeve. Otherwise, the sleeve can be configured like a planetary bolt and can be fastened alternatively or additionally. For example, the sleeve extends axially between the two wall elements and is clamped there. The sleeve can, in addition to the planetary bolts, transmit forces between the two wall elements and thus reinforce the planetary carrier. One or more clamping elements may be arranged between the sleeve and the planetary bolt. One or more clamping elements may also be arranged within the sleeve. The sleeve may, for example, guide clamping elements during assembly, for example at least the clamping elements between the sleeve and the planetary bolt or clamping elements within the sleeve. This may simplify the assembly of the planetary carrier.

In one embodiment, it is provided that the planetary carrier is configured to form an oil guide to the mounting of the planetary gear on the planetary bolt. At least part of the oil guide can be formed by the planetary bolt. For example, the planetary bolt, which is configured as a hollow shaft, can form a first axial oil channel of the oil guide with its through-opening. In addition, the planetary bolt can form one or more radial through-openings to a mounting area of the associated planetary gear. There, oil can flow then to the bearing of the planetary gear, for example, supported by a centrifugal force. The oil guide and thus lubrication can be used, for example, to lubricate the planetary gear bearing directly on the planetary bolt, which reduces the amount of oil required and makes lubrication particularly reliable. For the oil supply, the gearbox or planetary gear set can have an oil guide element, such as a radial disk with an oil guide axially extending towards one of the two wall elements. This oil guide element can be arranged axially adjacent to one of the two wall elements. For example, at least one of the two wall elements can have a through-opening to the planetary bolt, which extends from a side facing away from the other wall element to a side facing the other wall element.

An oil channel of the oil guide can be formed between the planetary bolt and the sleeve. This oil channel can be configured for active lubrication of the planetary gear bearing. For example, an active lubrication can be a lubrication in which pressure is generated by a pump or other means without necessarily requiring rotation of the planetary carrier for a supply. The oil channel can be essentially sealed and pressurizable.

In one embodiment, it is provided that an oil reservoir for passive lubrication is formed within the sleeve. This oil reservoir can, for example, be supplied by the oil channel described above or by a further through-opening in one of the wall elements. The oil reservoir is formed, for example, by an interior space of the sleeve and is at least partially delimited axially by the wall elements. The oil reservoir may be connected to the oil channel described above or to another radial through-opening through which lubrication is supplied to the bearing of the planetary gear. The passive lubrication can be a lubrication caused by the rotation of the planetary carrier and the corresponding centrifugal forces. Passive lubrication can, for example, take effect in the event of active lubrication failure and, alternatively or additionally, provide emergency lubrication. Thus, a basic supply of the bearing can be ensured until operation is stopped or maintenance is carried out. This is particularly beneficial for systems with high maintenance costs, like wind turbines, as it helps ensure continued operation or, at the very least, prevent damage that would be very difficult to repair. Due to the size of planetary bolts in wind turbines, the oil reservoir in the sleeve can easily be made large enough for this purpose.

In one embodiment, it is provided that the planetary bolt is configured in two pieces. For example, the planetary bolt is held together solely by clamping. The planetary bolt can, for example, be divided axially. A first part may, for example, be in contact only with the first of the two wall elements, and a second part only with the second of the two wall elements. At their contact point with each other, the two parts may, for example, have a step, a shoulder, a recess, or other seating surfaces. The two-piece structure can simplify assembly. Alternatively, the planetary bolt may also be configured as a single piece.

In one embodiment, it is provided that the first wall element is configured to form a first seat on which the planetary bolt is arranged. Alternatively or additionally, the second wall element can form a second seat on which the planetary bolt is arranged. Through the respective seat, the transmission of force to the planetary bolt can be improved. In addition, the respective seat can improve the centering of the planetary bolt and facilitate assembly. A seat can, for example, be formed by protruding regions and, alternatively or additionally, by recesses. The regions can, for example, protrude axially or be axially recessed. The planetary bolt can have corresponding regions with which the seat engages.

In one embodiment, it is provided that the respective seat is configured as a recess on a side of the respective wall element facing the planetary bolt. This side may also be oriented toward the planetary gear and, alternatively or additionally, toward the other wall element. The recess may, for example, be formed as a circumferential groove. For example, the shape of the recess may correspond to a cross-sectional shape of the planetary bolt. For example, the seat may be formed by an annular recess which corresponds to a round cross-section of a cylindrical planetary bolt formed as a hollow shaft. Alternatively or additionally, the wall element may also have protruding regions which form the seat. For example, a protruding ring may engage in a central through-opening of the planetary bolt.

In one embodiment, it is provided that the respective seat tapers away from the planetary bolt. For example, the seat may taper axially away from the planetary bolt or become narrower otherwise. The bottom of a groove forming the seat may be narrower than its upper opening. Due to the taper, the planetary bolt can also be pressed in the circumferential direction by the clamping. This allows tangential forces to be transmitted particularly well. In addition, the taper allows the planetary bolt to be additionally centered during clamping.

In one embodiment, it is provided that the planetary carrier has a bridge element, which is clamped between the two wall elements that are fastened together by the clamping device. The bridge element can be arranged radially outside the planetary bolt or bolts. The bridge element provides additional stiffening of the planetary carrier between the two wall elements. The bridge element is, for example, a metallic component, such as a cast part or a forged part. The bridge element can be a component separate from the two wall elements. Instead of a bridge element, a bridge section can also be formed integrally on one of the two wall elements, which can then be configured analogously to the bridge element and is also referred to below as a bridge element, although it does not form a separate component. The bridge element has, for example, one or more through-openings through which respective clamping elements of the clamping device extend. The bridge element extends, for example, axially between the two wall elements or at least between the two sides of the wall elements facing the planetary bolt. The bridge element can be fastened in the same way as planetary bolts, for example with associated seats on the two wall elements. By being arranged radially outside the planetary bolt or bolts, the bridge element can significantly increase the torsional stiffness of the planetary carrier. For example, several bridge elements may also be provided. The designs for one bridge element may apply equally to all bridge elements, where applicable.

In one embodiment, it is provided that the bridge element is arranged at a distance from the planetary bolt in the circumferential direction. For example, the bridge element may be arranged in the circumferential direction between two planetary bolts. This allows for ample space for the planetary gears and also avoids a building space conflict with toothing regions.

In one embodiment, it is provided that a dowel pin is arranged between at least the first wall element and the bridge element. Alternatively or additionally, a dowel pin may be arranged between at least the second wall element and the bridge element. Several dowel pins may also be arranged there. With the respective dowel pin, force transmission between the bridge element and the respective wall elements can be improved by simple means in order to stiffen the planetary carrier.

In one embodiment, it is provided that the planetary carrier has at least two planetary bolts spaced apart from each other in the circumferential direction. The first wall element may have a recess in the circumferential region between the two planetary bolts. Alternatively or additionally, the second wall element may have a recess in the circumferential region between the two planetary bolts. For each pair of circumferentially adjacent planetary bolts a recess may be provided. The recess may, for example, be configured as a bump indentation. The wall elements may, due to the recesses in the case of three planetary bolts, also have a substantially triangular basic shape. The recess allows for the planetary carrier to be lightweight and may require little material, while losing little or no stiffness relevant to operation.

A second aspect relates to a planetary gear set for a gearbox. The planetary gear set may have the planetary carrier according to the first aspect. Respective advantages and further features can be found in the description of the first aspect, whereby embodiments of the first aspect also form embodiments of the second aspect and vice versa. The planetary gear set may, for example, also comprise at least one sun gear and, alternatively or additionally, at least one ring gear. The planetary gear set may comprise one planetary gear rotatably mounted on each planetary bolt of the planetary carrier. The planetary gear set may, for example, form part of a gearbox of a wind turbine or a vehicle.

A third aspect relates to a wind turbine. The wind turbine has a planetary gear set according to the second aspect. Alternatively or additionally, the wind turbine may have the planetary carrier according to the first aspect. Respective advantages and further features can be found in the description of the first and second aspects, whereby embodiments of the first or second aspect also form embodiments of the third aspect and vice versa. The wind turbine may have a tower and a nacelle mounted thereon. The nacelle may, for example, be mounted on the tower in a rotatable or non-rotatable manner. The wind turbine may, for example, have a rotor and a generator. The rotor may drive the generator via the gearbox to generate electrical energy. The rotor is connected to the gearbox via a rotor shaft, for example. The rotor may have a horizontal or vertical axis of rotation. The rotor may have two, three, four, or more rotor blades, for example, which are connected to the rotor shaft via a hub.

FIG. 1 illustrates in a schematic perspective view, a conventional planetary carrier 500. The planetary carrier 500 has axially opposite wall elements 502, 504, which are formed in one piece. Between the two wall elements 502, 504, bridge elements 506 extend radially outward which are formed integrally with the wall elements 502, 504. Several planetary gears 508 are rotatably mounted on the planetary carrier 500, only one of which is shown here for clarity. For this purpose, the planetary carrier 500 has one planetary bolt 510 per planetary gear 508. The planetary bolts 510 are inserted radially from the outside to the inside between the two wall elements 502, 504 for assembly with the associated planetary gear 508 already pushed on. In their end position, the planetary bolts 510 are then fastened on both sides, i.e., to the two wall elements 502, 504. In the example shown, the planetary bolt 510 is screwed to the respective wall element 502, 504 at the end side, in one embodiment using an additional end plate per end. The planetary carrier 500 forms a cage for the planetary gears 508 and also the planetary bolts 510.

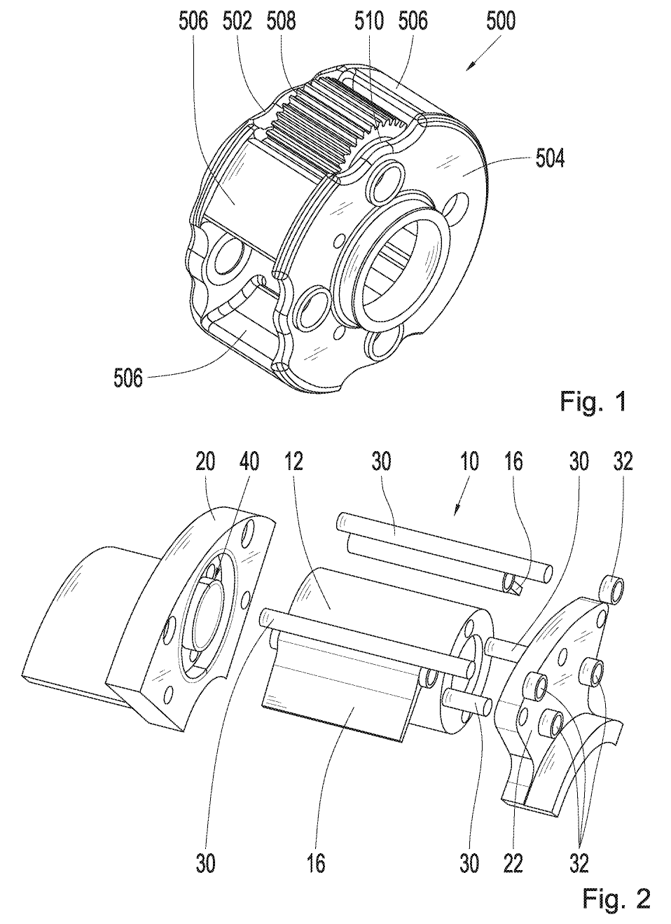

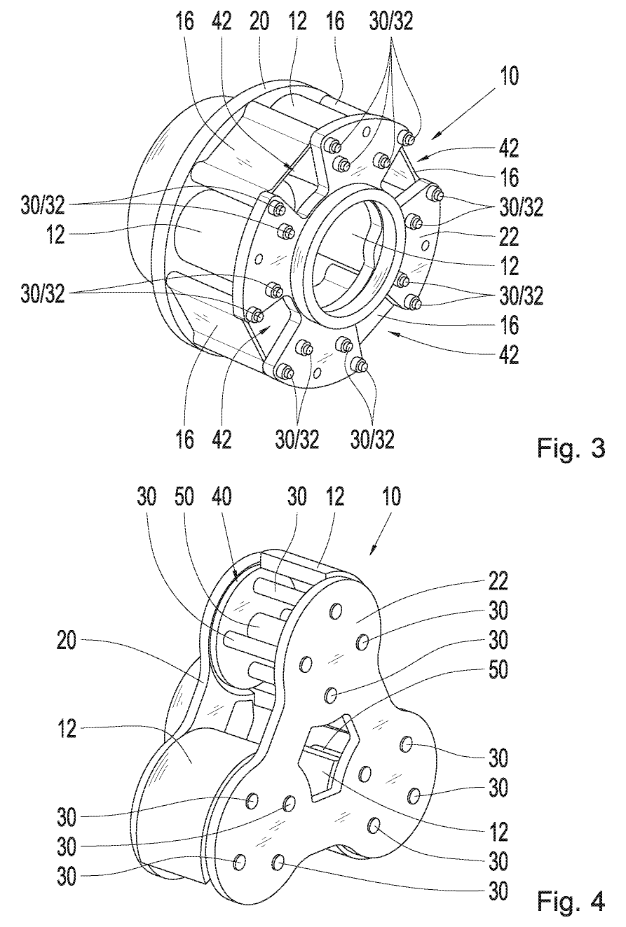

FIGS. 2 and FIG. 3 illustrate a planetary carrier 10 with a multi-part structure of its walls. As can be seen particularly well in FIG. 2, the planetary carrier 10 has a first wall element 20 and a second wall element 22, which are formed as separate components. In the example shown here, the planetary carrier 10 forms part of a gearbox for a wind turbine. The planetary carrier 10 has a central through-opening which is coaxial with an axis of rotation of the planetary carrier 10 and through which a shaft of the gearbox can be passed.

Between the two wall elements 20, 22, several planetary bolts 12 extend axially which are configured as hollow, tubular poles with a central through-opening. A planetary gear 14 is rotatably mounted on each planetary bolt 12. The two wall elements 20, 22 are fastened to each other with a clamping device. The clamping device thereby presses the wall elements 20, 22 toward each other. The planetary bolts 12 are clamped between the two wall elements 20, 22. The planetary bolts 12 thus hold the two wall elements 20, 22 at a desired distance and transmit forces between the two wall elements 20, 22 in the circumferential direction during operation of the wind turbine. In addition, in some embodiments, as shown in FIGS. 2 and FIG. 3, between the two wall elements 20, 22, bridge elements 16 are also clamped which also extend axially between the two wall elements 20, 22 and are arranged radially outside the two wall elements 20, 22. The bridge elements 16 also serve to maintain the distance and transfer forces between the two wall elements 20, 22. The bridge elements 16 are arranged radially outside the planetary bolts 12 and in the circumferential direction between two adjacent planetary bolts 12. In the example shown in FIGS. 2 and FIG. 3, the bridge elements 16 are formed as separate components. The planetary carrier 10 together with the two wall elements 20, 22 and the bridge elements 16 forms a cage for the planetary gears 14 and also the planetary bolts 12.

In the first embodiment of the planetary carrier 10 shown in FIGS. 2 and FIG. 3, the clamping device has a plurality of clamping elements 30. In a wall of the planetary bolt 12 delimiting the central through-opening, four through-openings are provided in each of which a screw or a bolt is arranged as a clamping element 30. In addition, the bridge elements 16 have a through-opening at each end region in the circumferential direction, in each of which a screw or a bolt is arranged as a clamping element 30. On the outside, on a side facing away from the planetary bolt 12, a counter element 32, in this case configured as a nut, is arranged on at least one of the two wall elements 20, 22 per clamping element 30. The clamping elements 30 extend through associated through-openings of the respective wall element 20, 22 in order to also be guided through the counter elements 32. Depending on their configuration, the clamping elements 30 can therefore be tightened on both sides or on one side from a front face of the planetary carrier 10 in order to clamp the planetary bolts 12 and the bridge elements 16 and to assemble the planetary carrier 10. This also allows for an assembly by stacking the components together. In one assembly variant, one of the two wall elements 20, 22 is placed on its front face. The various components and also the planetary gears 14 are stacked one after the other on the respective one of the two wall elements 20, 22. This can make assembly considerably easier, especially in the case of very large and heavy planetary carriers 10.

As can further be clearly seen in FIG. 2, the first wall element 20 has a seat 40 for each of the planetary bolts 12 on a side facing the second wall element 22 and thus also the planetary gears 14 and the planetary bolts 12. The seat 40 is formed as a circular recess and thus a groove, which corresponds to the shape of the wall of the planetary bolt 12. The planetary bolt 12 can be inserted here and then rests against the first wall element 20 in regions along its outer circumference and inner circumference. This allows forces to be transmitted particularly well in the circumferential direction and also in the radial direction. In one embodiment, the second wall element 22 has a corresponding seat 40, which is not visible in FIG. 2.

In FIG. 3 it can further be seen that at least the second wall element 20 has a recess 42 in the circumferential direction between two adjacent planetary bolts 12, which recess 42 extends in the region of the bridge elements 16. The second wall element 22 is therefore not configured as a plate with a basic circular shape that is essentially continuous in the circumferential direction, as is the case with the second wall element 504 in the planetary carrier 500 according to FIG. 1. The first wall element 20 is configured to be continuous without recesses. In one variant, the first wall element may also have recesses 42.

FIG. 4 shows a second embodiment of the planetary carrier 10. Only differences from the first embodiment according to FIGS. 2 and FIG. 3 are described. The planetary carrier 10 now has only three planetary bolts 12 instead of four planetary bolts 12. The bridge elements 16 are omitted. Recesses are now provided in the circumferential direction between the adjacent planetary bolts 12 on both wall elements 20, 22, resulting in a triangular basic shape of the two wall elements 20, 22. The planetary bolts 12 extend to a radial edge of the two wall elements 20, 22. The planetary bolts 12 are shown in section. This shows that the clamping elements 30 are no longer arranged in associated through-openings in the walls of the planetary bolts 12. Instead, four spaced-apart clamping elements 30 are provided per planetary bolt 12, which are arranged within the central through-opening of the respective planetary bolt 12. In addition, the planetary carrier 10 is shown in the second embodiment from a side in which the clamping elements 30 rest with a head on the second wall element 22.

In addition, the second embodiment of the planetary carrier 10 has a sleeve 50 per planetary bolt 12, which is arranged inside the planetary bolt 12. This sleeve 50 is configured as a solid pin in one variant and as a hollow shaft in another variant. The sleeve 50 serves as a spacer element during assembly. In one embodiment, a seat is provided for the sleeves 50 in each of the two wall elements 20, 22, which is configured analogously to the seat 40 for the planetary bolts 12. The sleeves 50 are then clamped in place and also transmit forces, thereby additionally stiffening the planetary carrier 10. In one variant, the sleeves 50 are formed integrally with one of the two wall elements 20, 22, and in another variant, they are each formed as a separate component.

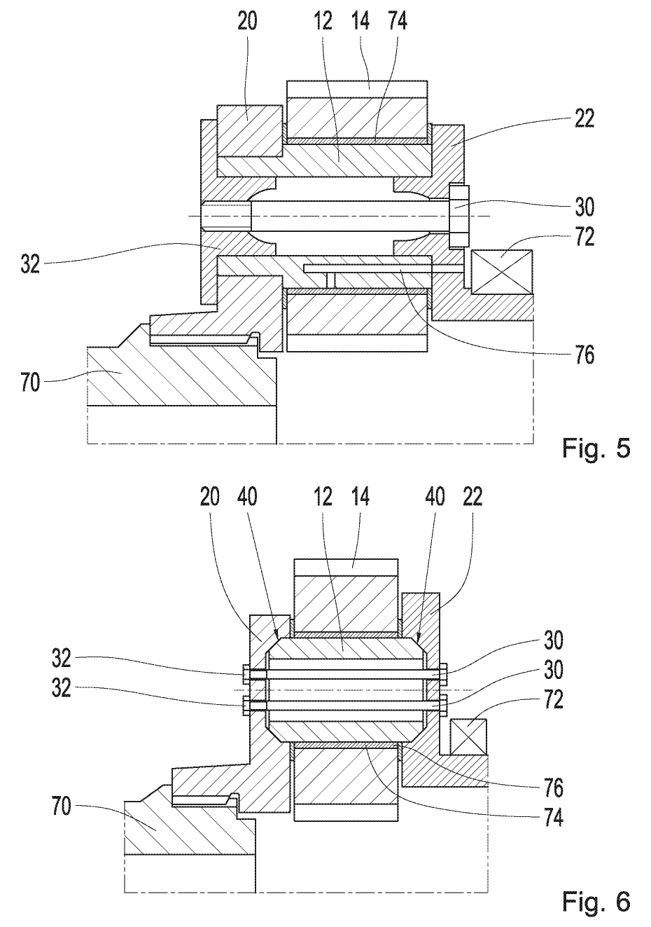

FIG. 5 shows in a sectional view details of the fastening of one of the planetary bolts 12 to the two wall elements 20, 22, as well as further details of the planetary gear set with the planetary carrier 10. A sun gear 70 of a further planetary gear set is connected to the first wall element 20 via a toothing. The second wall element 22 is mounted via a roller bearing 72. The planetary gear 14 is mounted on the planetary bolt 12 via a friction bearing 74. An oil channel 76 for lubricating the friction bearing 74 is formed in the wall of the planetary bolt 12. The counter element 32 is configured here as a plate which bears against the front face of the first wall element 20 on a side facing away from the planetary gear 14. In addition, the counter element 32 has an axial protrusion which extends into the planetary bolt 12 in the region of the first wall element 20. The first wall element 20 has a through-opening in which the planetary bolt 12 is seated with an end region . In addition, the planetary bolt 12 forms a step at this end region so that the planetary bolt 12 also rests on the front face of the first wall element 12 on a side facing the planetary gear 14. The second wall element 22 has a protrusion which extends into the planetary bolt 12 at an adjacent end region of the planetary bolt 12. In both wall elements 20, 22, a seat for the planetary bolt 12 is formed, which defines a mounting position and additionally enables force transmission in the circumferential direction. The second wall element 22 has a central through-opening through which the clamping element 30 extends in the form of a screw. The counter element 32 has a central threaded bore into which the clamping element 30 is screwed.

FIG. 6 shows a variation of the configuration shown in FIG. 5. Only the differences are explained. Several clamping elements 30 are now provided per planetary bolt 30. The counter element 32 is now no longer configured as a plate, but as a simple locking nut. In this case, the counter element 32 is arranged on the outside of the first wall element 20. In one variant, the counter element 32 is also arranged on the outside of the second wall element 22. In yet another variant, the clamping element 30 has a thread on both sides and two counter elements 32 are used per clamping element 30.

The seat 40 is also configured differently for the two wall elements 20, 22. A circular recess without a central part, which is not recessed, is now provided. The recess tapers in each of the wall elements 20, 22 in one direction axially away from the planetary gear 14 and thus away from the other of the two wall elements 22, 20. The inserted end regions of the planetary bolts 12 taper correspondingly. When the planetary bolts 12 are clamped in place, the end regions are pressed radially into the respective seat 40 from the outside, which can improve force transmission and centering.

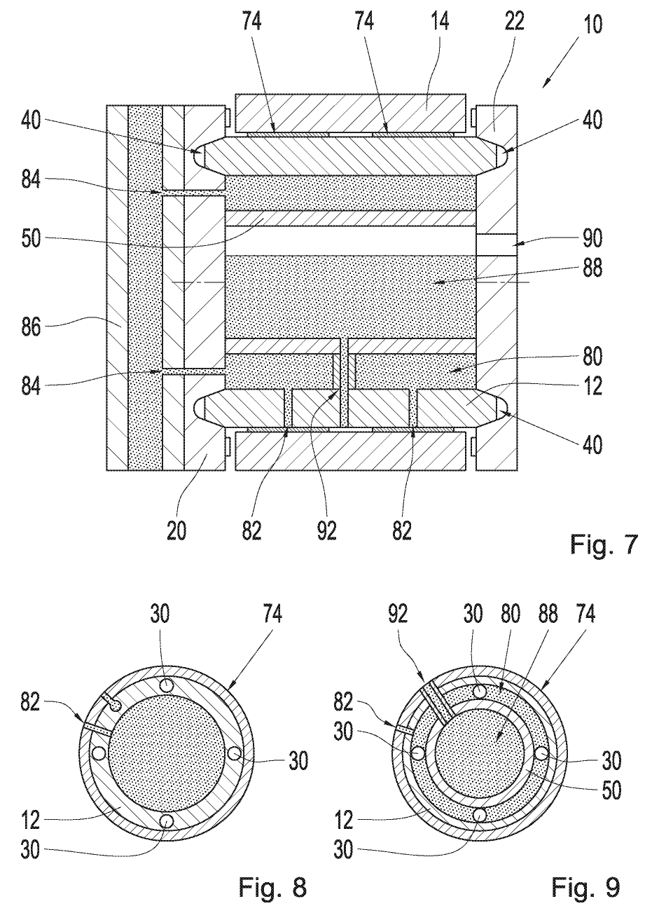

FIG. 7 shows a variation of the configuration shown in FIG. 6. Only the differences are explained. The clamping elements 30 are not shown in this schematic representation for the sake of clarity. This variant again features the sleeve 50. The sleeve 50 is configured as a hollow shaft. The planetary carrier 10 forms an oil guide to the bearing of the planetary gear 14 on each planetary bolt 12. An oil channel 80 is formed radially between the sleeve 50 and the planetary bolt 12, which is connected by radial through-openings 82 to the friction bearing 74 of the planetary gear 14 for its lubrication. The oil channel 80 can also be supplied with oil via an axial through-opening 84 in the first wall element 20. Axially adjacent to the first wall element 20, an oil distribution ring 86 is arranged, through which the oil channel 80 is fluidically connected to a pressure supply for active lubrication of the friction bearings 74. An oil reservoir 88 is also formed inside the sleeve 50. This oil reservoir 88 is supplied with oil passively or actively via an axial through-opening 90 in the second wall element 22. The oil reservoir 88 is not necessarily pressurized. The oil reservoir 88 is also connected to the respective friction bearings 74 for their lubrication via a radial channel 92, which runs through a radial through-opening in the sleeve 50 and the planetary bolt 12. The oil reservoir 88 passively lubricates the respective friction bearings 74 by centrifugal force during rotation of the planetary carrier 10 and thus also in the event of a failure of the active lubrication. FIG. 9 illustrates this configuration of the oil guide again in a further sectional view.

In the configuration of FIG. 7, the seat 40 for the planetary bolt 12 is also formed differently in each of the two wall elements 20, 22. The seat 40 is now again formed by an annular recess. This tapers in an axial direction away from the planetary gear set 14, similar to the seat 40 in the configuration of FIG. 6. The wall of the planetary bolt 12 also tapers correspondingly in each end region. The planetary bolt 12 can thus be pressed well into the respective seat 40.

FIG. 8 shows a variant of an oil guide without the sleeve 50. The oil channel for lubricating the friction bearings 74 is now simply formed by the central through-opening in the planetary bolt 12.

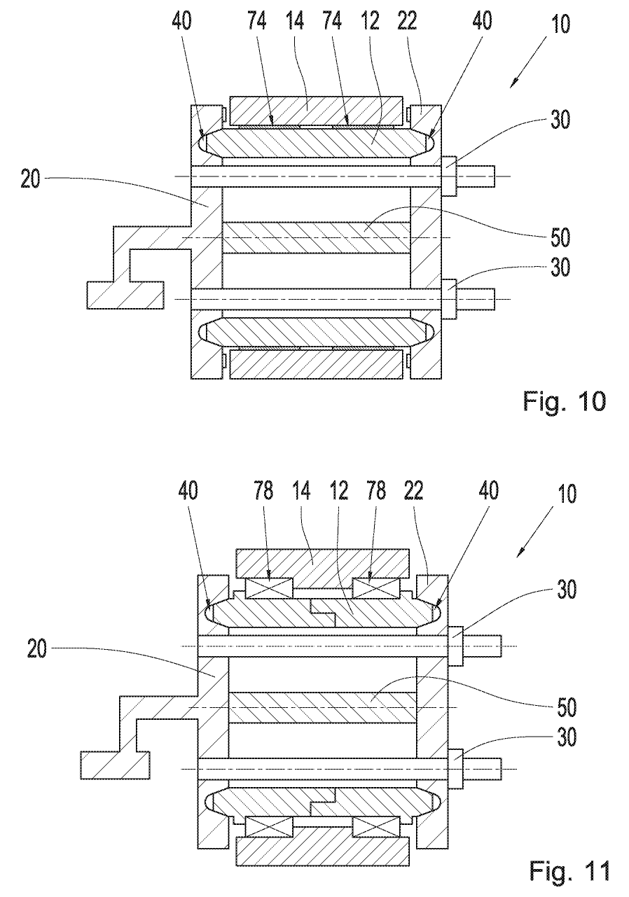

FIG. 10 shows a further variant of the fastening of the two wall elements 20, 22 to each other, which is based on the configuration of FIG. 7. Only the differences are explained. The oil guide is omitted in the variant shown, but may be present in other variants. The sleeve 50 is configured as a solid pin, as in the configuration according to FIG. 2. The clamping elements 30 are screwed into the first wall element 20 and rest against the second wall element 22 on the outside with their heads. A counter element 32 is omitted. The clamping elements 30 are arranged radially between the sleeve 50 and the planetary bolt 12.

FIG. 11 shows a further variant based on the configuration of FIG. 10. Only the differences are explained. The planetary bolt 12 is configured in two parts here. In addition, instead of friction bearings 74, roller bearings 78 are now provided for mounting the planetary gears 14 on the planetary bolt 12. An axial support for the planetary gears 14 on the two wall elements 20, 22, for example by means of a roller bearing or friction bearing is omitted. Instead, the roller bearings 78 guide the planetary gears 14 axially, whereby an inner ring of the roller bearings 78 is supported on shoulders of the planetary bolt 12. A first part of the planetary bolt 12 is arranged in the seat 40 on the first wall element 20 and forms a shoulder at an opposite axial end region. A second part of the planetary bolt 12 rests against this shoulder with a corresponding shoulder and is arranged in the seat 40 on the second wall element 22. The division of the planetary bolt 12 is axially centered here. In other embodiments, the division is not in an axial center.

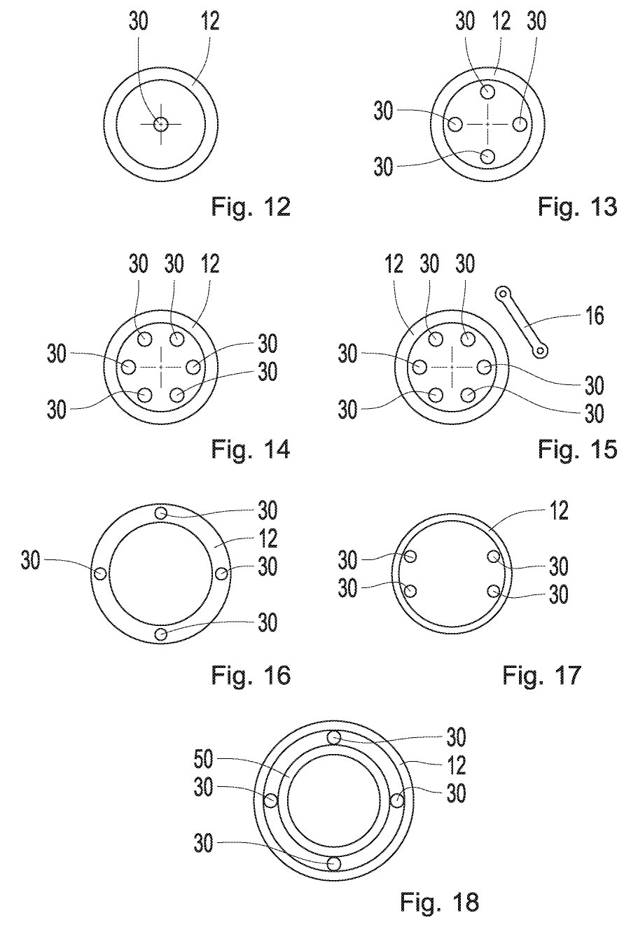

FIGS. 12 to 18 illustrate various arrangements of the clamping elements 30 relative to the planetary bolts 12. In the variant of FIG. 12, one clamping element 30 arranged centrally in the through-opening of the planetary bolt 12 is provided per planetary bolt 30. In the variant of FIG. 13, four evenly spaced clamping elements 30 are arranged on a common radius in the through-opening of the planetary bolt 12 per planetary bolt 30. In the variant shown in FIG. 14, instead of four, six evenly spaced clamping elements 30 are arranged on a common radius in the through-opening of the planetary bolt 12 per planetary bolt 30. FIG. 15 additionally illustrates the position of a bridge element 16 radially outside the planetary bolt 12 and is otherwise identical to FIG. 14. In the variant shown in FIG. 16 , four clamping elements 30 are arranged in the wall of the planetary bolt 12 in associated through-openings, as also shown in FIG. 2. In the variant shown in FIG. 17, the four clamping elements 30 are not evenly spaced within the planetary bolt 12. In the variant shown in FIG. 18, the four evenly spaced clamping elements 30 are arranged radially between the sleeve 50, which is formed as a hollow shaft, and the planetary bolt 12.

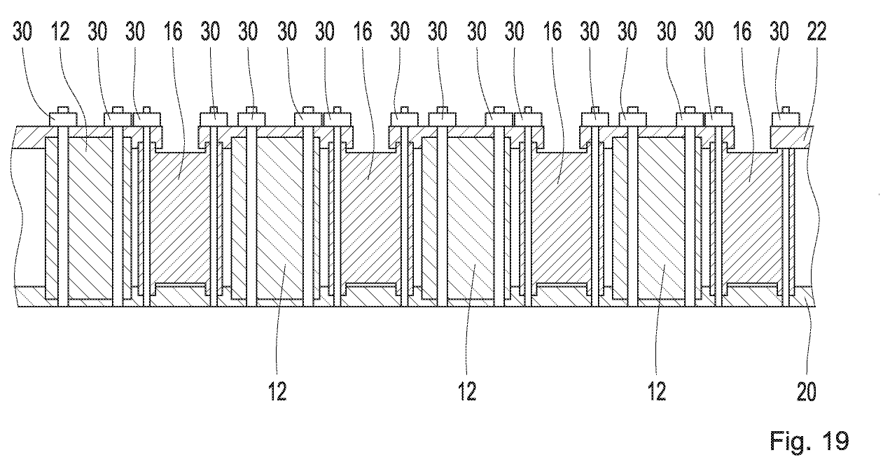

FIGS. 19 to 22 illustrate, in an unrolled view, various fastening configurations for the bridge elements 16 and the planetary bolts 12.

In the variant shown in FIG. 19, the clamping elements 30 are inserted on one side through the second wall element 22 in the region of the planetary bolts 12 for assembly and screwed into a corresponding threaded hole in the first wall element 20. The bridge elements 16 are clamped analogously at each end region in the circumferential direction by the clamping elements 30.

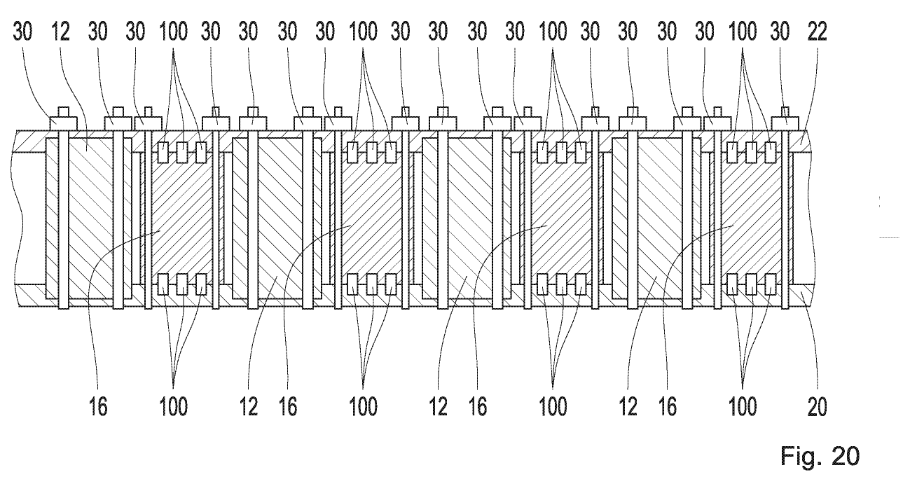

In the variant shown in FIG. 20, additional dowel pins 100 are provided, which are inserted into corresponding blind holes in the bridge element 16 and one of the two wall elements 20, 22.

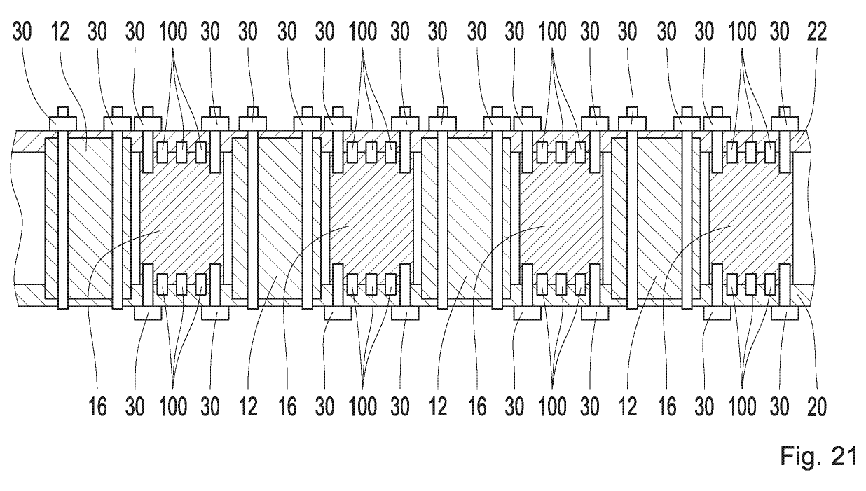

In the variant shown in FIG. 21, the bridge elements 16 are now screwed axially on both sides by clamping elements 30. The clamping elements 30 in the region of the bridge elements 16 are each guided through corresponding through-openings of one of the two wall elements 20, 22 and screwed into a threaded hole in the bridge element 16.

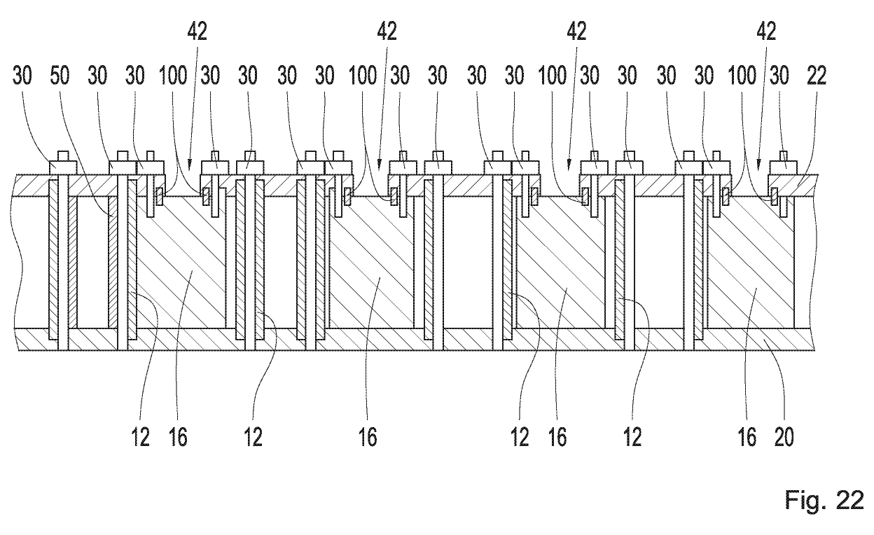

In the variant shown in FIG. 22, the bridge elements 16 are formed as a single piece as part of the first wall element 20 instead of as separate components. The bridge elements 16 are then screwed to the second wall element 22 by clamping elements 30. The clamping elements 30 in the region of the bridge elements 16 are each arranged in a through-opening of the second wall element 22 and screwed into a threaded hole with the bridge element 16. In addition, only on the side of the second wall element 22 between the bridge element 16 and the second wall element 22 two dowel pins 100 per bridge element 16 are provided.

In addition, FIG. 22 shows the sleeve 50 on one of the planetary bolts 12. This illustrates that in each of the variants from FIGS. 19 to FIG. 22, the sleeve 50 can also be arranged inside each planetary bolt 12. In the variants shown in FIGS. 19 to 22, the planetary bolts 12 are then configured as hollow shafts and not as solid bolts, as shown.

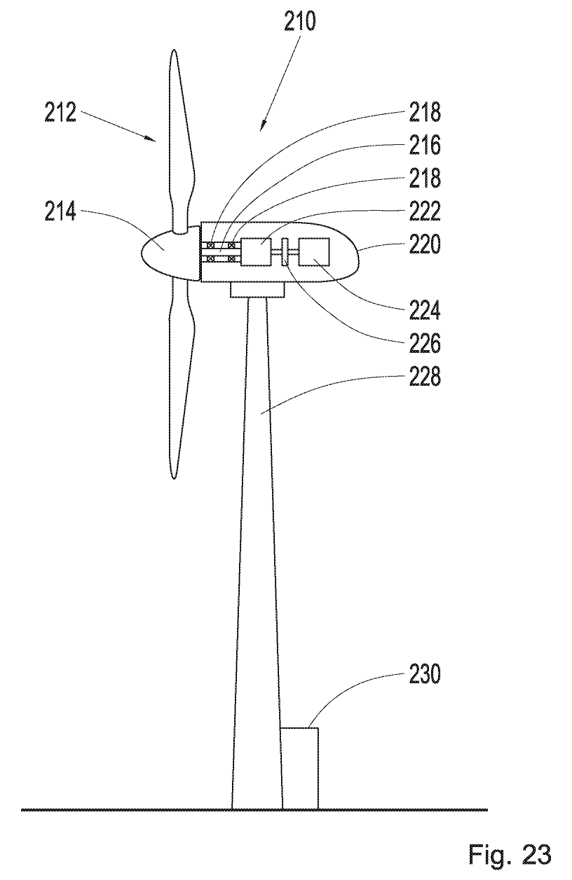

FIG. 23 illustrates a wind turbine 210 with a gearbox 222 in which the planetary carrier 10 can be installed as part of a planetary gear set in accordance with one of the embodiments described with reference to FIGS. 1 to 22. The wind turbine 210 has a rotor 212 which is held on a rotor shaft 216 via a hub 214. The axis of rotation of the rotor shaft 216 extends substantially horizontally. The rotor shaft 216 is mounted in a nacelle 220 via two roller bearings 218. A housing is provided for this purpose, which is attached to a machine bed of the nacelle 220. The rotor shaft 216 is mechanically operatively connected to a generator 224 via the gearbox 222. In the example shown, the planetary carrier 10 is permanently connected to the rotor shaft 216 in a rotationally fixed manner. A brake 226 is also arranged in the operative connection between the gearbox 222 and the generator 224, which acts on an input shaft of the generator 224. The nacelle 220 is rotatably mounted at an upper end of a tower 228, which is anchored to the ground. In one embodiment, the wind turbine 210 is configured as an offshore turbine. In addition to the tower 228, the wind turbine 210 also has a power connection 230.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

10 planetary carrier

12 planetary bolt

14 planetary gear

16 bridge elements

20 first wall element

22 second wall element

30 clamping element

32 counter element

40 seat

42 recess

50 sleeve

70 sun gear

72 roller bearing

74 friction bearing

76 oil channel

78 roller bearing

80 oil channel

82 radial through-opening

84 axial through-opening

86 oil distribution ring

88 oil reservoir

90 axial through-opening

92 radial channel

200 wind turbine

212 rotor

214 hub

216 rotor shaft

218 roller bearing

220 nacelle

222 gearbox

224 generator

226 brake

228 tower

230 power connection

100 dowel pins

500 planetary carrier

502 first wall element

504 second wall element

506 bridge element

508 planetary gear

510 planetary bolt

1. A planetary carrier for a planetary gear set, comprising:
a first wall element;
a second wall element; and
a planetary bolt configured to rotatably support a planetary gear thereon,
wherein the first wall element and the second wall element are fastened to each other by at least one clamping device, and
wherein the planetary bolt is clamped between the first wall element and the second wall element by the clamping device.

2. The planetary carrier according to claim 1, wherein the planetary bolt is configured as a hollow shaft.

3. The planetary carrier according to claim 2, wherein a clamping element of the clamping device is arranged inside the planetary bolt.

4. The planetary carrier according to claim 2, wherein the planetary carrier has a sleeve which is arranged inside the planetary bolt.

5. The planetary carrier according to claim 4, wherein the planetary carrier forms an oil guide to a bearing of the planetary gear on the planetary bolt, wherein an oil channel of the oil guide is formed between the planetary bolt and the sleeve and is configured for active lubrication of the bearing of the planetary gear.

6. The planetary carrier according to claim 5, wherein an oil reservoir for passive lubrication is formed inside the sleeve.

7. The planetary carrier according to claim 1, wherein the planetary bolt is formed in two parts.

8. The planetary carrier according to claim 1, wherein the first wall element forms a first seat on which the planetary bolt is arranged, and the second wall element forms a second seat on which the planetary bolt is arranged.

9. The planetary carrier according to claim 1, wherein a respective seat is formed as a recess in a side of the respective wall element facing the planetary bolt.

10. The planetary carrier according to claim 9, wherein the respective seat tapers away from the planetary bolt.

11. The planetary carrier according to claim 1, wherein the planetary carrier has a bridge element which is clamped between the first wall element and the second wall element by the clamping device, wherein the bridge element is arranged radially outside the planetary bolt.

12. The planetary carrier according to claim 11, wherein the bridge element is arranged at a distance from the planetary bolt in a circumferential direction.

13. The planetary carrier according to claim 11, wherein a dowel pin is arranged between at least one of the first wall element and the second wall element and the bridge element.

14. The planetary carrier according to claim 1, wherein the planetary carrier has at least two planetary bolts spaced apart from each other in a circumferential direction, wherein the first wall element has a recess in a circumferential region between the at least two planetary bolts.

15. A planetary gear set for a gearbox, wherein the planetary gear set has at least one planetary carrier according to claim 1.

16. A wind turbine with a gearbox which has the planetary carrier according to claim 1.

17. A wind turbine with a gearbox which has the planetary gear set according to claim 15.
